(19) United States
(12) Patent Application Publication
(10) Pub. No.: US 2019/0034067 A1
(43) Pub. Date: Jan. 31, 2019

(54) SEAMLESS USER-DIRECTED CONFIGURATION OF APPLICATIONS DURING RUNTIME

(71) Applicant: SAP SE, Walldorf (DE)

(72) Inventors: Markus Latzina, Wiesenbach (DE); Slavin Donchev, Mannheim (DE)

(21) Appl. No.: 15/827,185

(22) Filed: Nov. 30, 2017

Related U.S. Application Data
(60) Provisional application No. 62/538,497, filed on Jul. 28, 2017.

(51) Int. Cl. G06F 3/0484

(52) U.S. Cl. CPC G06F 3/04847

(57) ABSTRACT

At design time, a Use Logic Entity (ULE) and ULE Configuration Element (UCE) is defined for a particular Context. At run time, the defined ULE and UCE are placed into the particular Context. The defined ULE and UCE are rendered within a user interface associated with the particular Context. A user interface manipulation event associated with either the ULE or the UCE is received, and the user interface is dynamically configured based upon at least the received user interface manipulation event.

### CLAIM OF PRIORITY AND CROSS REFERENCE TO RELATED APPLICATIONS

This application claims priority under 35 USC § 120 to U.S. patent application Ser. No. 62/538,497, filed on Jul. 28, 2017, the entire contents of which are hereby incorporated by reference.

This application is also related to and filed in conjunction with U.S. Utility Patent Application Serial No. ______, filed on ______, entitled “Building and Using Behavior-based Applications,” (Attorney Docket No. 22135-1033001/170126US02), which claims priority under 35 USC § 120 with U.S. Provisional Patent Application Ser. No. 62/538,482, filed on Jul. 28, 2017, entitled “Building and Using Behavior-based Applications,” (Attorney Docket No. 22135-1033P01/170126US01), the entire contents of each which are hereby incorporated by reference.

### BACKGROUND

The ability of an end user (“user”) to perform user-driven configuration or adaptation of an Application (“App” or “Context”) at runtime under current software architectural patterns (for example, Model-View-Controller (MVC)) is typically very limited, creating a gap between desired configurations or adaptations to an App and an ability to perform them. For example, configuration or adaptation changes (such as, to functional scope, look and feel as part of visual appearance, and interaction capabilities) are often supported through dialog elements that are separate from the user interface (UI) of the App a user wishes to configure/adapt. In order to use such a dialog, the user much locate, open, and work through the dialog's interface. In desktop-type Apps, it is very common that provided configuration UIs are located in a separate App section for example, labeled as “Extras”, “Options”, “Properties”, and the like). For web- or cloud-based Apps (for example, executed in a web browser), separate App sections are normally not provided, as, in principle, users should not be bothered with configuration or adaptation of web-based Apps with separate dialogs, screens, and the like. Regardless of whether an App is for a desktop or web-based, common configuration options are typically separated from the actual App. As a result, necessary actions to perform a desired configuration or adaptation change to an App can be difficult to discern, inefficient, and tedious for a user.

### SUMMARY

The present disclosure describes seamless user-directed configuration of applications during runtime.

In an implementation, at design time, a Use Logic Entity (ULE) and ULE Configuration Element (UCE) is defined for a particular Application (“App” or “Context”). At run time, the defined ULE and UCE are placed into the particular Context. The defined ULE and UCE are rendered within a user interface associated with the particular Context. A user interface manipulation event associated with either the ULE or the UCE is received, and the user interface is dynamically configured based upon at least the received user interface manipulation event.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, with the described approach, a user is permitted to perform user-driven configuration or adaptation of an Application at runtime. Users are not bothered with configuration or adaptation of Apps using separate dialogs or screens, but can make changes directly within the App while in use. Second, if a user decides to choose and interact with data types or attributes for which the App was not initially designed for, the user is not necessarily limited in configuration capabilities with respect to the data types or attributes. ULEs, which are embodiments of App use logic, permit direct interaction by users and enable seamless App configuration to be embedded within the App itself. Third, intuitive user understanding is provided through immediate feedback of effects of manipulating one or more ULEs with respect to an App or Apps. Users are allowed to create and benefit from directly configuring Apps, during use, in powerful and innovative ways. Fourth, principles of machine learning can be applied to the concept of ULEs and the handling of ULEs at the level of a user interaction at a UI level. Through the integration of the principles of machine learning, an App can be dynamically adapted to use data types or objects which were not anticipated or planned for by software engineers. Other advantages will be apparent to those of ordinary skill in the art.

The details of one or more implementations of the subject matter of this specification are set forth in the accompanying drawings and the description. Other features, aspects, and advantages of the subject matter will become apparent from the description, the drawings, and the claims.

### DESCRIPTION OF DRAWINGS

FIGS. 1A & 1B are block diagrams illustrating removal of a Use Logic Entity (ULE) from an Application (App) A, according to an implementation of the present disclosure.

FIG. 2 is a block diagram illustrating example options for transferring a ULE to an App, according to an implementation of the present disclosure.

FIG. 3 is a block diagram illustrating a completed transfer of a ULE from App B to App A of FIG. 2, according to an implementation of the present disclosure.

FIG. 4 is a flowchart of an example method for seamless, user-directed configuration of Apps during runtime, according to an implementation of the present disclosure.

FIG. 5 is a block diagram illustrating an example computer system used to provide computational functionalities associated with described algorithms, methods, functions, processes, flows, and procedures as described in the instant disclosure, according to an implementation of the present disclosure.

Like reference numbers and designations in the various drawings indicate like elements.

### DETAILED DESCRIPTION

The following detailed description describes seamless, user-directed configuration of Applications during runtime, and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The ability of an end user (“user”) to perform user-driven configuration or adaptation of an Application (“App” or “Context”) at runtime under current software architectural patterns (for example, Model-View-Controller (MVC)) is typically very limited, creating a gap between desired configurations or adaptations to an App and an ability to perform them. For example, configuration or adaptation changes (such as, to functional scope, look and feel as part of visual appearance, and interaction capabilities) are often supported through dialog elements that are separate from the user interface (UI) of the App a user wishes to configure/adapt. In order to use such a dialog, the user much locate, open, and work through the dialog's interface. In desktop-type Apps, it is very common that provided configuration UIs are located in a separate App section for example, labeled as “Extras”, “Options”, “Properties”, and the like). For web- or cloud-based Apps (for example, executed in a web browser), separate App sections are normally not provided, as, in principle, users should not be bothered with configuration or adaptation of web-based Apps with separate dialogs, screens, and the like. Regardless of whether an App is for a desktop or web-based, common configuration options are typically separated from the actual App. As a result, necessary actions to perform a desired configuration or adaptation change to an App can be difficult to discern, inefficient, and tedious for a user.

One reason for the described gap can include a lack of mapping of mapping configuration parameters to an App (or parts of the App) in a direct and easy-to-comprehend manner. For example, the lack of mapping can occur in at least two ways: 1) configuration parameters may be laid out differently when compared to an App UI layout including an arrangement of various UI elements and controls and 2) configuration attributes may be defined and labeled in ways which make it difficult for users to understand a relationship to any App parts or attributes on a UI level or during an actual UI interaction. Another reason for the described gap arises from the fact that software engineers—as in the example of modern web Apps—may not have included any configuration options, or only configuration options for a limited subset of particular App attributes.

Configuration options are also typically confined by data or a database model around which an App was designed. As a result, if a user decides to choose and interact with data types or attributes for which the App was not designed for, the user is necessarily limited in configuration capabilities with respect to the data types or attributes. While, in principle, conventional configuration capabilities can be configured to include options to define unplanned for data and how to use it with an App, the provided options will not provide a seamless user experience. In fact, interactions with the App for the user would mimic typical App definition actions by software engineers during the design phase of the App.

Described is the provision of seamless, user-directed configuration of Apps during runtime for a given App (for example, an App executing in a web browser). At a UI level where users interact with the App (or parts of the App), the App includes Use Logic Entities (ULE) which are embodiments of App use logic and together make up the App. A ULE is defined by a particular form and potential for user interaction in an associated App. For example, ULEs might include App use logic directed to graphing, sorting, simple visualization, forced UI layouts, and connecting UI elements within the associated App.

Use logic differs from App logic as it is transparent to the user and a ULE associated with the use logic can be directly interacted with by users. For example, in some implementations, a ULE could be implemented as a Behavior as described in the co-pending U.S. Provisional Patent Application identified above in the CROSS REFERENCE TO RELATED APPLICATIONS. As will be appreciated by those of ordinary skill in the art, the described use of Behaviors demonstrates but one particular approach of numerous possible approaches to implement the use of ULEs and is not meant to limit this disclosure in any way. Other implementation approaches, inasmuch as they are consistent with the concepts described in this disclosure, are also considered to be within the scope of this disclosure.

The App also needs to be designed in such a way that a ULE is represented at the level of the App UI for direct manipulation by users. In this way, the user is equipped with a handle to directly modify the appearance and behavior of the App (for example, by switching ON and OFF individual ULEs, adding/removing ULEs, and associated actions).

The ULEs and their description as UI elements for user interaction constitute a type of self-representation (or “self-description”) with respect to the App that can be exposed for user interaction. Practically, ULEs can be represented in a dedicated area of the UI. This representation exposes clearly which ULE features are applicable to a particular App, and permits intuitive user understanding through immediate feedback of the effects of manipulating one or more ULEs (for example, adding or removing a ULE from an App). In an example with respect to a ULE implemented by a Behavior, a ULE defining a sorting-type action could be represented on UI as a UI widget that can be dragged and dropped into the App UI to permit addition of the sorting-type functionality into the App. Similarly, dragging the ULE out of the App, removes the sorting-type functionality from the App.

Users are able to benefit from prior experience using a number of Apps and their associated interaction capabilities (for example, rendering and interaction functionality). Assume that users have gained some proficiency with interacting with ULEs associated with Apps A, B, and C. Now, when starting to work with a new App, D, users can appreciate particular ULEs with which they have previously encountered when working with the Apps A, B, or C. Subsequently, given that ULEs can be easily transferred across Apps, users could choose to drag-and-drop/copy-and-paste (or similar functionality) a particular ULE, M, from App A, B, or C into App D.

As a result, App D can be seamlessly reconfigured “on-the-fly,” so to speak. As a result, App D would now include the added ULE M, as part of its actual App scope. Enabling users to configure Apps in this manner allows configuration functionalities to be leveraged to an unprecedented level. Users are allowed to create and benefit from directly configuring Apps, during use at runtime, in powerful and innovative ways.

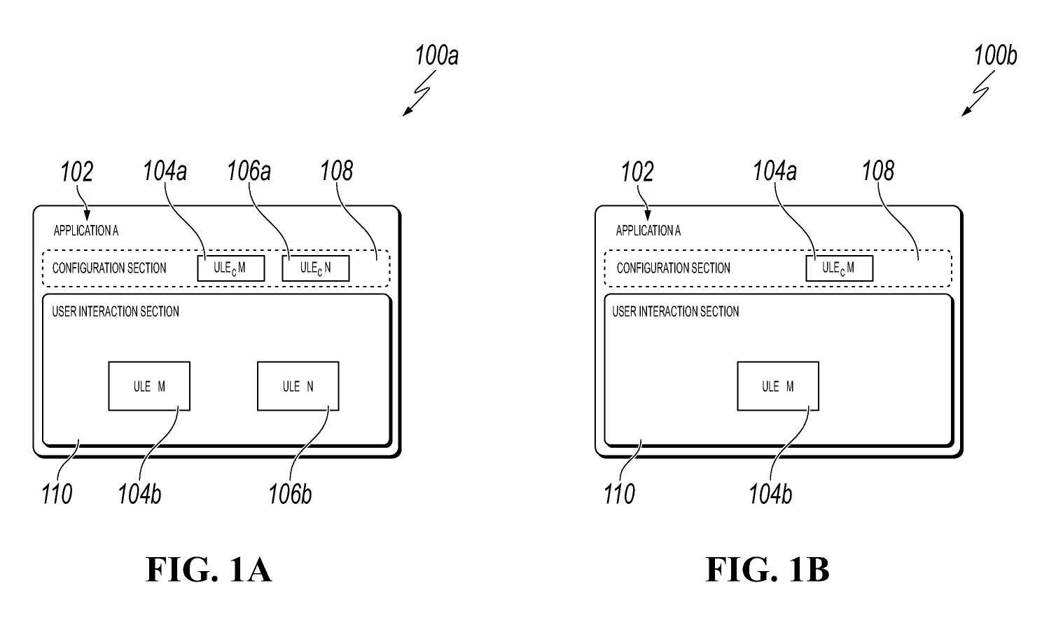

FIGS. 1A & 1B are block diagrams 100a & 100b, respectively, illustrating removal of a ULE from an App A, according to an implementation of the present disclosure. As illustrated in FIG. 1A, App A 102 includes ULEs as both a ULE Configuration Element (UCE) ULE_{c}M 104a and ULE_{c}N 106a in a Configuration Section 108 and associated ULEs ULE M 104b and ULE N 106b, respectively, in User Interaction Section 110. Note, the positioning of App elements or regions and ULEs do not necessarily imply a particular screen layout or spatial arrangement. UCEs provide a user selectable representation (for example, an icon or other UI widget) of a particular ULE that can also be interacted with in order to implement various operations (for example, copy, delete, transfer, and move) with respect to ULEs and Apps.

Turning to FIG. 1B, a user selects to remove ULE_{c}N 106a from the Configuration Section 108. Following the removal of the UCE 106a, as an effect, associated ULE N 106b is also removed from App A 102. Note that any objects rendered in the User Interaction Section 110 can then change based on the removal of a particular UCE and ULE depending on the effect the ULE 106b use logic imparted to App A 102 (for example, removal of a UCE providing sorting-type functionality can result in rendered objects reverting to a non-sorted state). In some implementations, if the user decides to remove a ULE from App A 102 (for example, ULE 106b), the associated UCE ULE_{c}N 106a can remain in the configuration section 108 to allow the user to easily re-add the ULE to App A 102 if desired. Alternatively, the user can recover the deleted ULE N 106b from a deleted storage (for example, a clipboard).

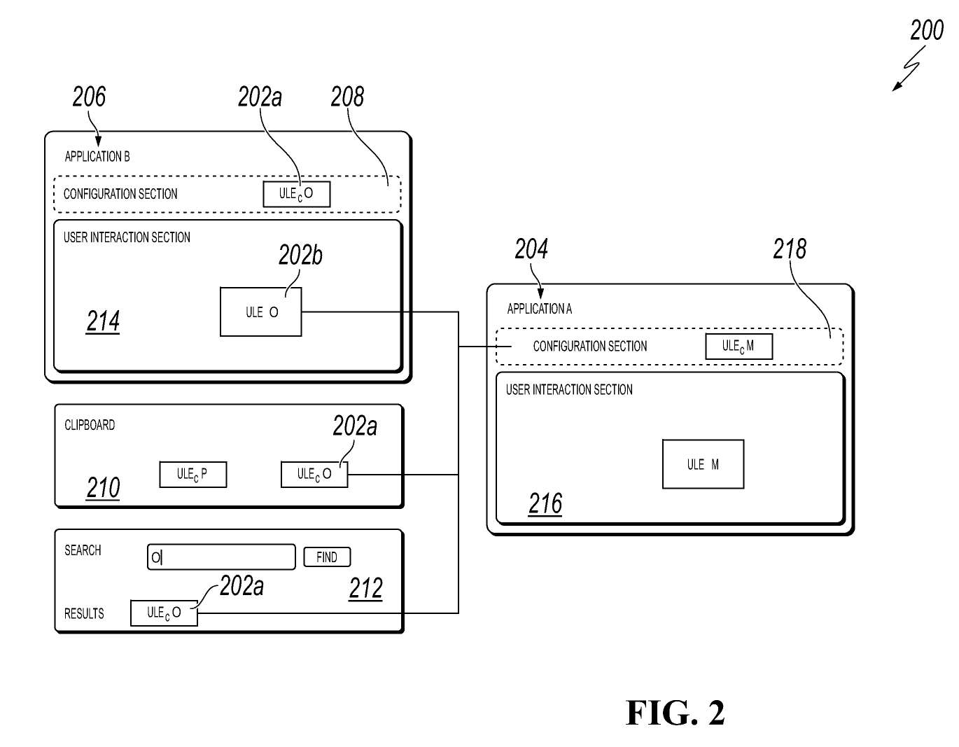

FIG. 2 is a block diagram 200 illustrating example options for transferring a ULE to an App, according to an implementation of the present disclosure. As illustrated, ULE_{c}O 202a (and associated ULE O 202b) can be transferred to App A 204 from App B 206 (from Configuration Section 208), a Clipboard 210 (which can include various UCEs), or a Search UI 212 (which can support retrieving ULEs from a database).

As will be understood by those of ordinary skill in the art, there are many other possible Applications/UI elements, other than those illustrated, that can be used to transfer UCEs and ULEs. In other implementations, not illustrated, a user could transfer a ULE directly from a User Interaction Section (for example, User Interaction Section 214 of Application B 206 to User Interaction Section 216 of Application A 204). Note that the UCE associated with the transferred ULE (for example, ULE_{c}O 202a would also be transferred to Configuration Section 218 of Application A 204). Whether or not the transfer would delete ULE_{c}O 202a and ULE O 202b from Application B 206 would depend on whether the transfer was a copy, cut-and-paste, or other type of operation.

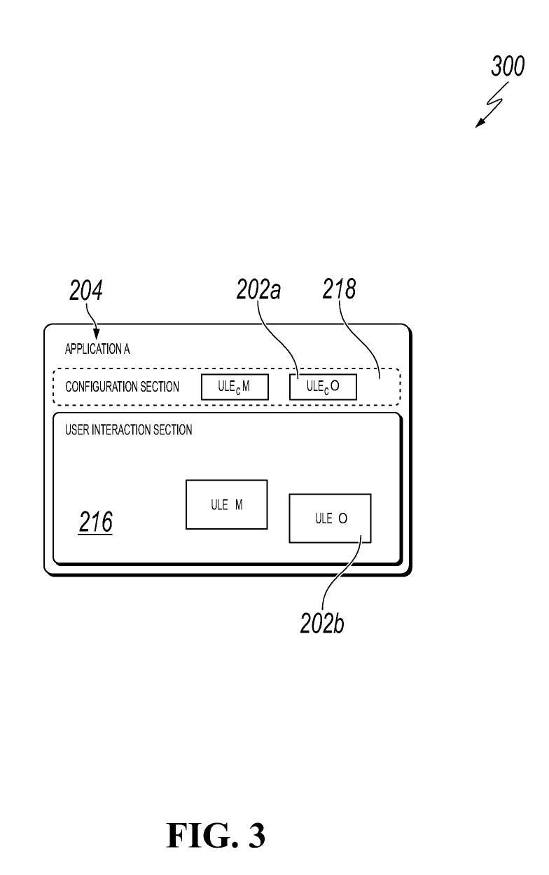

FIG. 3 is a block diagram 300 illustrating a completed transfer of a ULE from App B to App A of FIG. 2, according to an implementation of the present disclosure. Note that FIG. 3 illustrates the transfer of ULE O 202b and associated ULE_{c}O 202a to the User Interaction Section 216 and Configuration Section 218, respectively, of App A 204).

In some implementations, principles of machine learning technologies (for example, machine learning algorithms, artificial intelligence engines, or pattern matching algorithms) can be applied to the concept of ULEs and the handling of ULEs at the level of user interaction, at a UI level. A practical example could focus on the transfer of objects from a source App S to a target App T, where a particular machine learning algorithm can be applied to match the rendering (for example, style, color, font, and size) of the object from App S so that it matches the ULEs of App T. Assume that in App S the object is row data within a table. The user decides to transfer (for example, by selecting and dragging the row in the UI) this data object to App T, which features ULEs for visually linking data objects. If the source data object (here, row data) has several attributes, if preserved after the transfer to App T, this fact considerably impedes interactions for users since they might not be able to link the row data on the level of the object with other objects already present in App T. Instead, users may feel that they are required to decide which attribute(s) of the row data that they want to link with another object in App T. However, a machine learning algorithm could analyze the situation and determine that the row data could be “transformed” into a unitary object that can be linked to other objects. Accordingly, limitations of having to decide for any particular attribute for the purpose of linking to other objects can be mitigated.

As an example with respect to UCEs/ULEs implemented as Behaviors, the knowledge gathered by machine learning technologies can be used with respect to objects associated with an App that can be affected by one or more Behaviors (for example, a Sortable or Simple Visualizer Behavior). With the gathered knowledge, one or more Behaviors (and, analogously, UCEs/ULEs) can be parameterized for enhanced functionality. As an example, a particular Behavior can be parameterized to receive the size of a list of airline data from an airline reservation website and to adjust the size of a UI widget appropriately or to display particular information deemed most important within the widget. Additionally, one or more Behaviors (and, analogously, UCEs/ULEs) could be optionally configured by the machine learning technologies with additional parameters (for example, in associated event handlers).

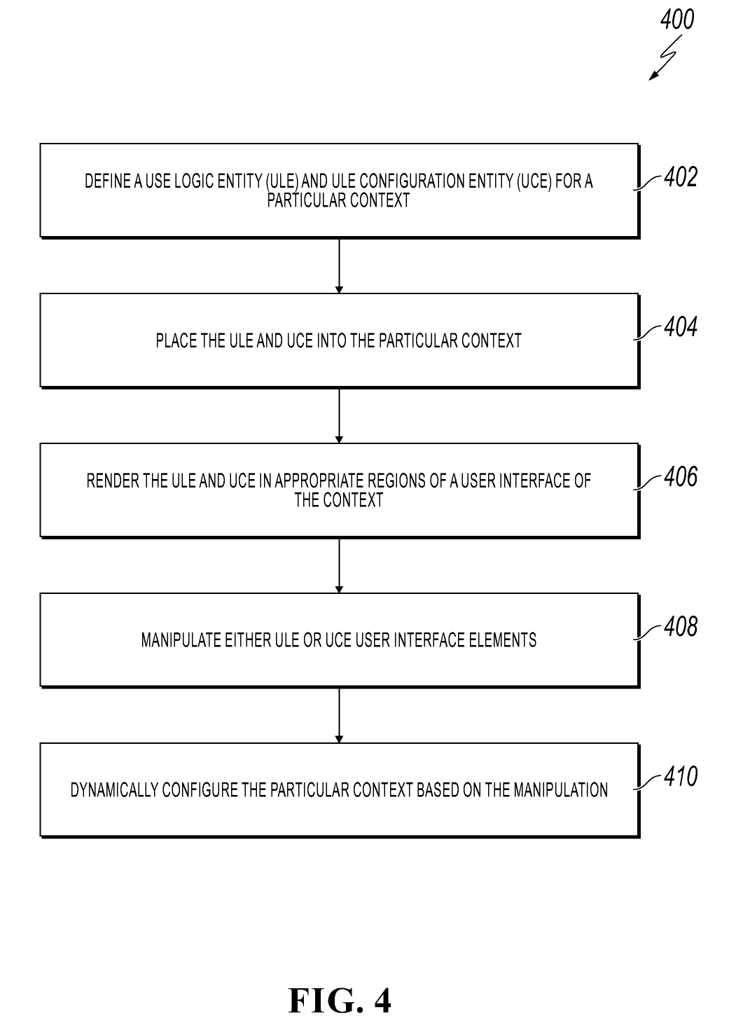

FIG. 4 is a flowchart of an example method 400 for seamless, user-directed configuration of Applications during runtime, according to an implementation of the present disclosure. For clarity of presentation, the description that follows generally describes method 400 in the context of the other figures in this description. However, it will be understood that method 400 may be performed, for example, by any suitable system, environment, software, and hardware, or a combination of systems, environments, software, and hardware, as appropriate. In some implementations, various steps of method 400 can be run in parallel, in combination, in loops, or in any order.

At 402, a ULE and associated UCE are defined for a particular App/Context. From 402, method 400 proceeds to 404.

At 404, the defined ULE and associated UCE are placed into the particular Context. For example, the Context could be configured to initialize with a default set of ULEs/UCEs or to present available ULEs/UCEs in a particular region of the same or a different Context. From 404, method 400 proceeds to 406.

At 406, the ULEs/UCEs are rendered within the particular/different Context. From 406, method 400 proceeds to 408.

At 408, either the ULE or associated UCE is manipulated by the user using a user interface of the Context. User interface manipulation events associated with either the ULE or the UCE are received in response to the user interface manipulation. From 408, method 400 proceeds to 410.

At 410, the particular Context user interface is dynamically configured based upon the received user interface manipulation events. After 410, method 400 stops.

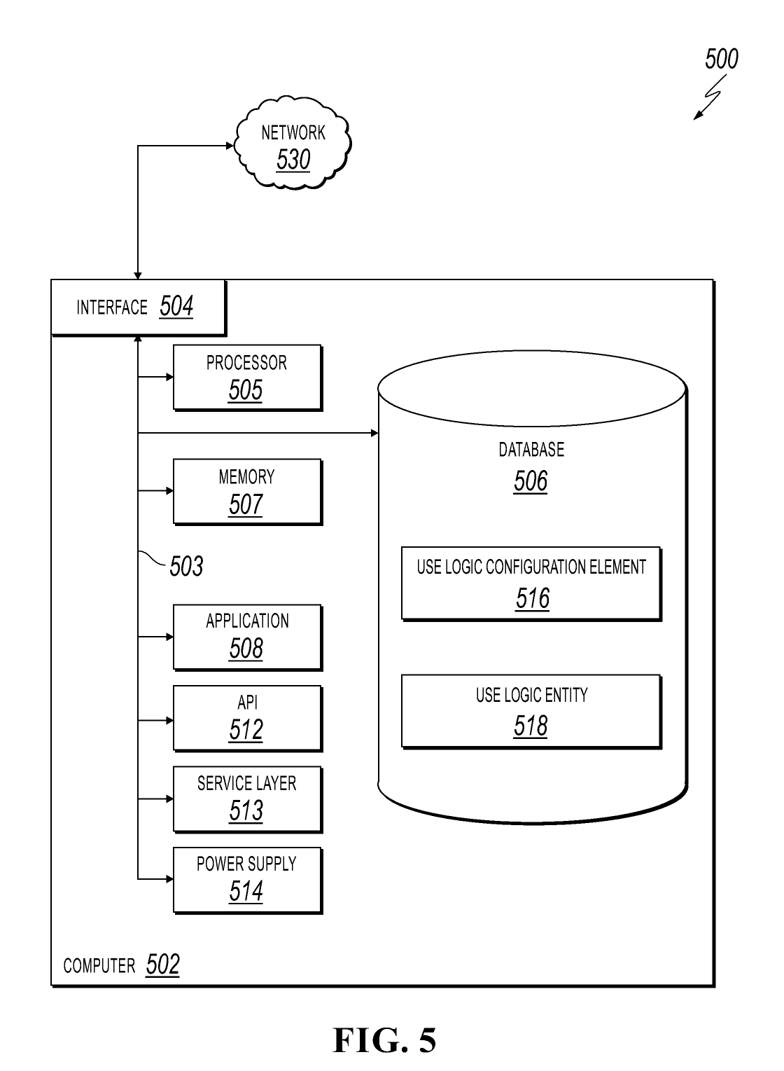

FIG. 5 is a block diagram of an example computer system 500 used to provide computational functionalities associated with described algorithms, methods, functions, processes, flows, and procedures, as described in the instant disclosure, according to an implementation of the present disclosure. The illustrated computer 502 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 502 may comprise a computer that includes an input device, such as a keypad, keyboard, touch screen, or other device that can accept user information, and an output device that conveys information associated with the operation of the computer 502, including digital data, visual, or audio information (or a combination of information), or a graphical user interface (GUI).

The computer 502 can serve in a role as a client, network component, a server, a database or other persistency, or any other component (or a combination of roles) of a computer system for performing the subject matter described in the instant disclosure. The illustrated computer 502 is communicably coupled with a network 530. In some implementations, one or more components of the computer 502 may be configured to operate within environments, including cloud-computing-based, local, global, or other environment (or a combination of environments).

At a high level, the computer 502 is an electronic computing device operable to receive, transmit, process, store, or manage data and information associated with the described subject matter. According to some implementations, the computer 502 may also include or be communicably coupled with an application server, e-mail server, web server, caching server, streaming data server, or other server (or a combination of servers).

The computer 502 can receive requests over network 530 from a client application (for example, executing on another computer 502) and respond to the received requests by processing the received requests using an appropriate software application(s). In addition, requests may also be sent to the computer 502 from internal users (for example, from a command console or by other appropriate access method), external or third-parties, other automated applications, as well as any other appropriate entities, individuals, systems, or computers.

Each of the components of the computer 502 can communicate using a system bus 503. In some implementations, any or all of the components of the computer 502, hardware or software (or a combination of both hardware and software), may interface with each other or the interface 504 (or a combination of both), over the system bus 503 using an application programming interface (API) 512 or a service layer 513 (or a combination of the API 512 and service layer 513). The API 512 may include specifications for routines, data structures, and object classes. The API 512 may be either computer-language independent or dependent and refer to a complete interface, a single function, or even a set of APIs. The service layer 513 provides software services to the computer 502 or other components (whether or not illustrated) that are communicably coupled to the computer 502. The functionality of the computer 502 may be accessible for all service consumers using this service layer. Software services, such as those provided by the service layer 513, provide reusable, defined functionalities through a defined interface. For example, the interface may be software written in JAVA, C++, or other suitable language providing data in extensible markup language (XML) format or other suitable format. While illustrated as an integrated component of the computer 502, alternative implementations may illustrate the API 512 or the service layer 513 as stand-alone components in relation to other components of the computer 502 or other components (whether or not illustrated) that are communicably coupled to the computer 502. Moreover, any or all parts of the API 512 or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502. The interface 504 is used by the computer 502 for communicating with other systems that are connected to the network 530 (whether illustrated or not) in a distributed environment. Generally, the interface 504 comprises logic encoded in software or hardware (or a combination of software and hardware) and is operable to communicate with the network 530. More specifically, the interface 504 may comprise software supporting one or more communication protocols associated with communications such that the network 530 or interface's hardware is operable to communicate physical signals within and outside of the illustrated computer 502.

The computer 502 includes a processor 505. Although illustrated as a single processor 505 in FIG. 5, two or more processors may be used according to particular needs, desires, or particular implementations of the computer 502. Generally, the processor 505 executes instructions and manipulates data to perform the operations of the computer 502 and any algorithms, methods, functions, processes, flows, and procedures as described in the instant disclosure.

The computer 502 also includes a database 506 that can hold data for the computer 502 or other components (or a combination of both) that can be connected to the network 530 (whether illustrated or not). For example, database 506 can be an in-memory, conventional, or other type of database storing data consistent with this disclosure. In some implementations, database 506 can be a combination of two or more different database types (for example, a hybrid in-memory and conventional database) according to particular needs, desires, or particular implementations of the computer 502 and the described functionality. Although illustrated as a single database 506 in FIG. 5, two or more databases (of the same or combination of types) can be used according to particular needs, desires, or particular implementations of the computer 502 and the described functionality. While database 506 is illustrated as an integral component of the computer 502, in alternative implementations, database 506 can be external to the computer 502. As illustrated, the database 506 holds a ULCE 516 and a ULE 518, as previously described.

The computer 502 also includes a memory 507 that can hold data for the computer 502 or other components (or a combination of both) that can be connected to the network 530 (whether illustrated or not). Memory 507 can store any data consistent with this disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same or combination of types) can be used according to particular needs, desires, or particular implementations of the computer 502 and the described functionality. While memory 507 is illustrated as an integral component of the computer 502, in alternative implementations, memory 507 can be external to the computer 502.

The application 508 is an algorithmic software engine providing functionality according to particular needs, desires, or particular implementations of the computer 502, particularly with respect to functionality described in this disclosure. For example, application 508 can serve as one or more components, modules, or applications. Further, although illustrated as a single application 508, the application 508 may be implemented as multiple applications 508 on the computer 502. In addition, although illustrated as integral to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion or management circuits (including recharging, standby, or other power management functionality). In some implementations, the power-supply 514 can include a power plug to allow the computer 502 to be plugged into a wall socket or other power source to, for example, power the computer 502 or recharge a rechargeable battery.

There may be any number of computers 502 associated with, or external to, a computer system containing computer 502, each computer 502 communicating over network 530. Further, the term “client,” “user,” and other appropriate terminology may be used interchangeably, as appropriate, without departing from the scope of this disclosure. Moreover, this disclosure contemplates that many users may use one computer 502, or that one user may use multiple computers 502.

Described implementations of the subject matter can include one or more features, alone or in combination.

For example, in a first implementation, a computer-implemented method, comprising: at design time: defining a Use Logic Entity (ULE) and ULE Configuration Element (UCE) for a particular Context; and at run time: placing the defined ULE and UCE into the particular Context; rendering the defined ULE and UCE within a graphical user interface associated with the particular Context; receiving a graphical user interface manipulation event associated with either the ULE or the UCE; and dynamically configuring the graphical user interface based upon at least the received graphical user interface manipulation event.

The foregoing and other described implementations can each, optionally, include one or more of the following features:

A first feature, combinable with any of the following features, wherein a UCE provides an interactable representation of a particular ULE.

A second feature, combinable with any of the previous or following features, wherein the Context is a software Application.

A third feature, combinable with any of the previous or following features, wherein the Context includes a configuration section and a user interaction section of the graphical user interface.

A fourth feature, combinable with any of the previous or following features, wherein the UCE is interacted with in the graphical user interface in order to implement various operations with respect the particular ULE.

A fifth feature, combinable with any of the previous or following features, wherein the UCE is interacted with in the configuration section of the graphical user interface.

A sixth feature, combinable with any of the previous or following features, wherein the ULE is interacted with in the user interaction section of the graphical user interface.

In a second implementation, a non-transitory, computer-readable medium storing one or more instructions executable by a computer system to perform operations comprising: at design time: defining a Use Logic Entity (ULE) and ULE Configuration Element (UCE) for a particular Context; and at run time: placing the defined ULE and UCE into the particular Context; rendering the defined ULE and UCE within a graphical user interface associated with the particular Context; receiving a graphical user interface manipulation event associated with either the ULE or the UCE; and dynamically configuring the graphical user interface based upon at least the received graphical user interface manipulation event.

The foregoing and other described implementations can each, optionally, include one or more of the following features:

A first feature, combinable with any of the following features, wherein a UCE provides an interactable representation of a particular ULE.

A second feature, combinable with any of the previous or following features, wherein the Context is a software Application.

A third feature, combinable with any of the previous or following features, wherein the Context includes a configuration section and a user interaction section of the graphical user interface.

A fourth feature, combinable with any of the previous or following features, wherein the UCE is interacted with in the graphical user interface in order to implement various operations with respect the particular ULE.

A fifth feature, combinable with any of the previous or following features, wherein the UCE is interacted with in the configuration section of the graphical user interface.

A sixth feature, combinable with any of the previous or following features, wherein the ULE is interacted with in the user interaction section of the graphical user interface.

In a third implementation, a computer-implemented system, comprising: a computer memory; and a hardware processor interoperably coupled with the computer memory and configured to perform operations comprising: at design time: defining a Use Logic Entity (ULE) and ULE Configuration Element (UCE) for a particular Context; and at run time: placing the defined ULE and UCE into the particular Context; rendering the defined ULE and UCE within a graphical user interface associated with the particular Context; receiving a graphical user interface manipulation event associated with either the ULE or the UCE; and dynamically configuring the graphical user interface based upon at least the received graphical user interface manipulation event.

The foregoing and other described implementations can each, optionally, include one or more of the following features:

A first feature, combinable with any of the following features, wherein a UCE provides an interactable representation of a particular ULE.

A second feature, combinable with any of the previous or following features, wherein the Context is a software Application.

A third feature, combinable with any of the previous or following features, wherein the Context includes a configuration section and a user interaction section of the graphical user interface.

A fourth feature, combinable with any of the previous or following features, wherein the UCE is interacted with in the graphical user interface in order to implement various operations with respect the particular ULE.

A fifth feature, combinable with any of the previous or following features, wherein the UCE is interacted with in the configuration section of the graphical user interface.

A sixth feature, combinable with any of the previous or following features, wherein the ULE is interacted with in the user interaction section of the graphical user interface.

The foregoing and other described implementations can each, optionally, include one or more of any other feature or implementation, in whole or in part, described in this disclosure.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
at design time:
defining a Use Logic Entity (ULE) and ULE Configuration Element (UCE) for a particular Context; and
at run time:
placing the defined ULE and UCE into the particular Context;
rendering the defined ULE and UCE within a graphical user interface associated with the particular Context;
receiving a graphical user interface manipulation event associated with either the ULE or the UCE; and
dynamically configuring the graphical user interface based upon at least the received graphical user interface manipulation event.

2. The computer-implemented method of claim 1, wherein a UCE provides an interactable representation of a particular ULE.

3. The computer-implemented method of claim 1, wherein the Context is a software Application.

4. The computer-implemented method of claim 3, wherein the Context includes a configuration section and a user interaction section of the graphical user interface.

5. The computer-implemented method of claim 4, wherein the UCE is interacted with in the graphical user interface in order to implement various operations with respect the particular ULE.

6. The computer-implemented method of claim 5, wherein the UCE is interacted with in the configuration section of the graphical user interface.

7. The computer-implemented method of claim 5, wherein the ULE is interacted with in the user interaction section of the graphical user interface.

8. A non-transitory, computer-readable medium storing one or more instructions executable by a computer system to perform operations comprising:
at design time:
defining a Use Logic Entity (ULE) and ULE Configuration Element (UCE) for a particular Context; and
at run time:
placing the defined ULE and UCE into the particular Context;
rendering the defined ULE and UCE within a graphical user interface associated with the particular Context;
receiving a graphical user interface manipulation event associated with either the ULE or the UCE; and
dynamically configuring the graphical user interface based upon at least the received graphical user interface manipulation event.

9. The non-transitory, computer-readable medium of claim 8, wherein a UCE provides an interactable representation of a particular ULE.

10. The non-transitory, computer-readable medium of claim 8, wherein the Context is a software Application.

11. The non-transitory, computer-readable medium of claim 10, wherein the Context includes a configuration section and a user interaction section of the graphical user interface.

12. The non-transitory, computer-readable medium of claim 11, wherein the UCE is interacted with in the graphical user interface in order to implement various operations with respect the particular ULE.

13. The non-transitory, computer-readable medium of claim 12, wherein the UCE is interacted with in the configuration section of the graphical user interface.

14. The non-transitory, computer-readable medium of claim 12, wherein the ULE is interacted with in the user interaction section of the graphical user interface.

15. A computer-implemented system, comprising:
a computer memory; and
a hardware processor interoperably coupled with the computer memory and configured to perform operations comprising:
at design time:
defining a Use Logic Entity (ULE) and ULE Configuration Element (UCE) for a particular Context; and
at run time:
placing the defined ULE and UCE into the particular Context;
rendering the defined ULE and UCE within a graphical user interface associated with the particular Context;
receiving a graphical user interface manipulation event associated with either the ULE or the UCE; and
dynamically configuring the graphical user interface based upon at least the received graphical user interface manipulation event.

16. The computer-implemented system of claim 15, wherein a UCE provides an interactable representation of a particular ULE.

17. The computer-implemented system of claim 15, wherein the Context is a software Application.

18. The computer-implemented system of claim 17, wherein the Context includes a configuration section and a user interaction section of the graphical user interface.

19. The computer-implemented system of claim 18, wherein the UCE is interacted with in the graphical user interface in order to implement various operations with respect the particular ULE.

20. The computer-implemented system of claim 19, wherein the UCE is interacted with in the configuration section of the graphical user interface and the ULE is interacted with in the user interaction section of the graphical user interface.
